(19) United States
(12) Patent Application Publication
(10) Pub. No.: US 2009/0007753 A1
(43) Pub. Date: Jan. 8, 2009

(54) PRACTICE MUTE FOR STRING INSTRUMENTS

(75) Inventor: Roger Hsu, Taipei (TW)

Correspondence Address: RABIN & Berdo, PC, 1101 14TH STREET, NW, SUITE 500, WASHINGTON, DC, 20005, US

(73) Assignee: OTTO MUSICA CORPORATION, Taipei (TW)

(21) Appl. No.: 11/774,116

(22) Filed: Jul. 6, 2007

(51) Int. Cl. G10D 3/04

(52) U.S. Cl. 84/310

(57) ABSTRACT

A practice mute for string instruments includes a primary unit and at least one secondary unit. The primary unit is provided at a lower side with a groove in parallel with an axial direction of the primary unit, so that the primary unit may straddle a bridge of a string instrument with the groove engaged with a top of the bridge. The primary unit is also provided at the lower side with a plurality of recesses perpendicular to the axial direction of the primary unit, allowing strings of the string instrument to extend through the primary unit via the recesses. Part of the material of the primary unit at a predetermined position is removed to form at least one cavity for receiving the secondary unit therein. The primary and the secondary unit are made of different materials, so that the practice mute has reduced weight and provides improved sound-absorbing effect.

### FIELD OF THE INVENTION

The present invention relates to a practice mute, and more particularly to a practice mute for string instruments that is formed by combining a primary unit and at least one secondary unit embedded in the primary unit.

### BACKGROUND OF THE INVENTION

It is known a string instrument produces sound by means of vibrating a plurality of strings, and the vibration of strings is amplified via a sound box provided on a body of the string instrument. Conventionally, a bridge is located immediately on a top of the sound box. Strings are caused to pass through a top of the bridge, so that the bridge functions as a medium for transferring sound wave. When performing in a somewhat narrow space or doing practicing, a string instrument player would usually attach a mute to the bridge to damp the vibration of the strings, so as to lower the volume of produced sound.

As it is known among the string instrument players, it is troublesome to attach the conventional mute to the bridge, and the bridge tends to become damaged when the mute attached thereto is too tight or too heavy.

FIG. 1 shows a conventional practice mute 10 that has a simplified structure and is easier to manipulate. There is a wide choice of sizes and materials (including metal and rubber materials) for the practice mute 10, so that a performer may select a practice mute most suitable for the string instrument being played. The practice mute 10 is provided at a lower side with a groove 11 parallel to an axial direction of the practice mute, allowing the practice mute 10 to straddle the bridge. The practice mute 10 is also provided at the lower side with a plurality of recesses 12, via which the strings are extended to thereby reduce the volume of sound produced by plucking the strings.

The conventional practice mute 10 is usually made of a metal material to provide better sound-absorbing effect. However, the metal-made practice mute 10 is heavy and tends to damage the bridge. There are also rubber-made practice mutes having a largely reduced weight to avoid damaging the bridge. However, the rubber-made practice mutes are less effective in sound-absorbing.

Therefore, it is desirable to develop a practice mute that on the one hand has reduced weight and on the other hand provides good sound-absorbing effect to overcome the drawbacks in the conventional practice mutes.

### SUMMARY OF THE INVENTION

A primary object of the present invention is to provide a practice mute for string instruments that has reduced weight and provides improved sound-absorbing effect.

To achieve the above and other objects, the practice mute for string instruments according to the present invention includes a primary unit and at least one secondary unit. The primary unit is provided at a lower side with a groove in parallel with an axial direction of the primary unit, so that the primary unit may straddle a bridge of a string instrument with the groove engaged with a top of the bridge. The primary unit is also provided at the lower side with a plurality of recesses perpendicular to the axial direction of the primary unit, allowing strings of the string instrument to extend through the primary unit via the recesses. Part of the material of the primary unit at a predetermined position is removed to format least one cavity or chamber in or on the primary unit for receiving or embedding the secondary unit therein, so that the primary and the secondary unit together form an integral body.

The primary unit is preferably made of a rubber material. Part of the rubber material at a predetermined position inside or on an exterior of the primary unit is removed to form a cavity or a chamber, in which the secondary unit is received or imbedded. The secondary unit is preferably made of a metal material.

By combining the rubber-made primary unit and the metal-made secondary unit, the practice mute of the present invention may have a reduced overall weight, and provide improved sound-absorbing effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional practice mute for string instruments;

FIG. 2 is an assembled view showing a practice mute for string instruments according to the present invention is fixed to a bridge of a string instrument;

FIG. 3 is an exploded view showing the practice mute for string instruments according to the present invention is separated from the bridge of the string instrument;

FIG. 4 is a perspective view of the practice mute for string instruments according to the present invention;

FIG. 5 is a cross-sectional view of FIG. 4; and

FIG. 6 is a vertical sectional view of FIG. 4.

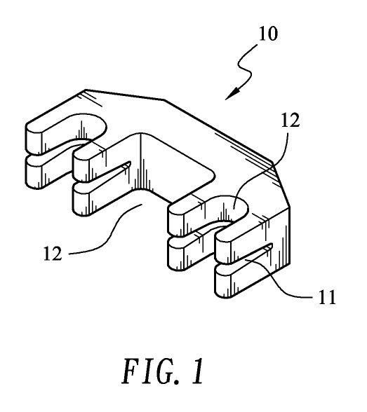

### DETAILED DESCRIPTION OF THE PREFERRED EMBODIMENTS

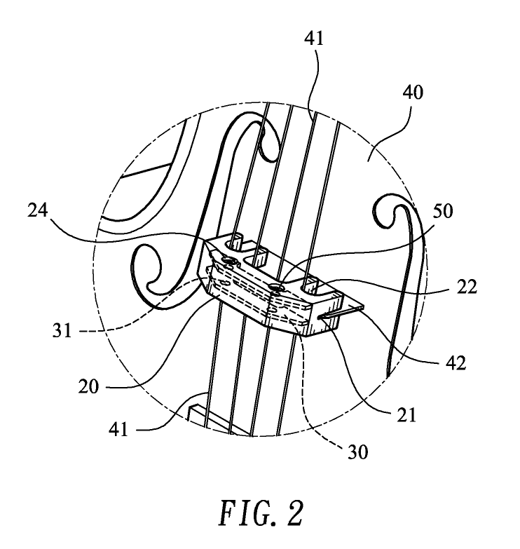

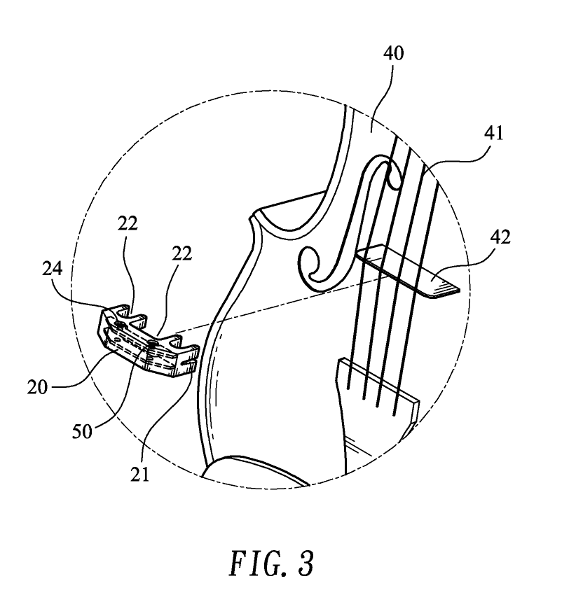

Please refer to FIGS. 2, 3, and 4. A practice mute for string instruments according to the present invention includes a primary unit 20 and at least one secondary unit 30 embedded in the primary unit 20. In the illustrated embodiment, the primary unit 20 is preferably made of a rubber material and provided at a lower side with a groove 21 in parallel with an axial direction of the primary unit 20, such that the primary unit 20 may straddle a bridge 42 of a string instrument 40 by engaging the groove 21 with a top of the bridge 42. The primary unit 20 is also provided at the lower side with a plurality of recesses 22 perpendicular to the axial direction of the primary unit 20, such that when the groove 21 on the practice mute is engaged with the bridge 42 of the string instrument 40, strings 41 of the string instrument 40 are allowed to extend through the practice mute via the recesses 22. Basically, the strings 41 extended through the recesses 22 are in contact with the recesses 22, so that the primary unit 20 is able to absorb the volume of sound produced by the strings 41.

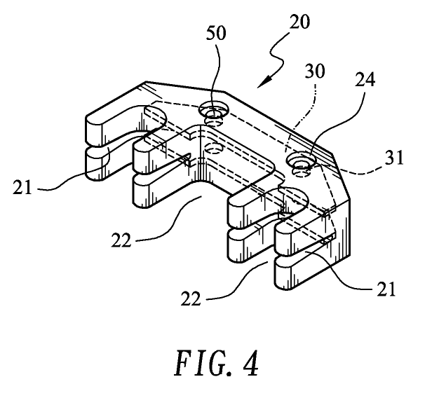

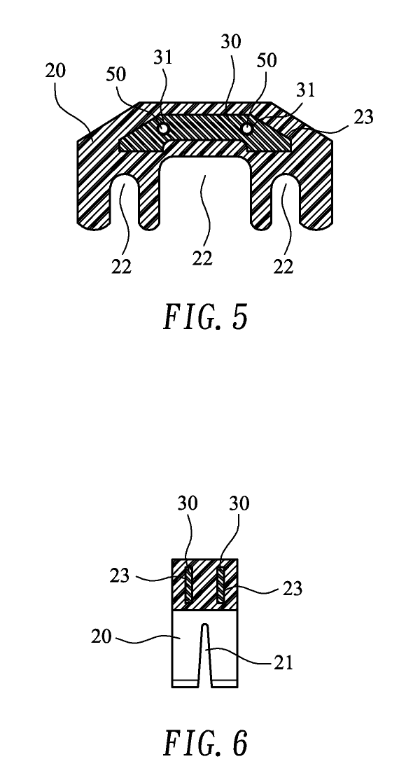

Please refer to FIGS. 4 and 5. In a preferred embodiment of the present invention, part of the material of the primary unit 20 at a predetermined position thereof is removed, so as to define at least one cavity or chamber 23 for receiving the at least one secondary unit 30 therein and thereby forming an integral body of the practice mute, as shown in FIGS. 5 and 6. In this preferred embodiment, the secondary unit 30 is preferably made of a metal material, so as to be easily combined with the rubber primary unit 20 to provide a relatively improved sound-absorbing effect while enable a reduced overall weight of the practice mute. As can also be seen from FIGS. 4 and 5, corresponding locking holes 24, 32 are provided on the primary unit 20 and the secondary unit 30, respectively. Fastening elements 50, such as pins, screws, rivets, or other similar items, maybe extended through the locking holes 24, 32 to thereby joint the primary and the secondary unit 20, 30 together as an integral body.

In another operable embodiment of the present invention, the primary unit 20 is made of a rubber material to possess a relatively high flexibility. In this case, it is not necessary to remove part of the material of the primary unit 20. In stead, the secondary unit 30 is directly embedded in the primary unit 20 to form an integral body.

In designing the practice mute for string instruments according to the present invention, the following points are taken into consideration:
1. The primary unit 20 is preferably made of a rubber material, and part of the material of the primary unit at a predetermined position is optionally removed to form at least one cavity or chamber 23 for receiving the secondary unit 30 therein, so that the practice mute may have an overall weight as low as possible. The problem of a damaged bridge 42 caused by a conventional heavy metal mute can therefore be overcome.
2. The predetermined position on the primary unit 20 for removing part of the mute material may be located inside or on an exterior of the primary unit 20, and may be expanded in area, changed in shape, or increased in number within an allowable limit.
3. The secondary unit 30 is preferably made of a metal material to create an increased sound-absorbing effect for the practice mute. As in the case of the primary unit, the secondary unit 30 is also changeable in number and shape thereof.

The practice mute of the present invention has simplified structure for easy fixing to a top of the bridge 42 of the string instrument 40. The secondary unit 30 may be received in the cavity or chamber 23 formed inside or on the primary unit 20, or be directly embedded in the rubber material of the primary unit 20, so that the completed practice mute for string instruments according to the present invention provides relatively improved sound-absorbing effect and has reduced overall weight, and can be more easily fixed to the top of the bridge 42. Moreover, the practice mute of the present invention also shows a spatial form different from that of conventional mutes for string instruments.

The present invention has been described with a preferred embodiment thereof and it is understood that many changes and modifications in the described embodiment can be carried out without departing from the scope and the spirit of the invention that is intended to be limited only by the appended claims.

1. A practice mute for string instruments, comprising a primary unit and at least one secondary unit;
the primary unit, made of a rubber material, being provided at a lower side with a groove parallel to an axial direction of the primary unit and a plurality of recesses perpendicular to the axial direction of the primary unit, such that the primary unit is configured to straddle a bridge of a string instrument with the groove engaged with a top of the bridge and strings of the string instrument extended through the recesses; and
the secondary unit, made of a metal material, being provided on the primary unit at a predetermined position.

2. (canceled)

3. (canceled)

4. The practice mute for string instruments as claimed in claim 1, wherein a portion of the primary unit at the predetermined position is removed to form a cavity or chamber for receiving the secondary unit therein; and
the predetermined position is located inside the primary unit.

5. (canceled)

6. (canceled)

7. The practice mute for string instruments as claimed in claim 1, wherein the primary and the secondary unit are correspondingly provided with locking holes, via which fastening elements are extended to join the primary and the secondary unit into one integral body.
